(19) United States
(12) Patent Application Publication
(10) Pub. No.: US 2005/0147054 A1
(43) Pub. Date: Jul. 7, 2005

(54) Navigational bar

(76) Inventors: Rose Pon Loo, Pleasanton, CA (US); Lewis W.B. Charnock, Harleysville, PA (US); Janaki P. Kumar, Palo Alto, CA (US); Benolin Jose, Santa Clara, CA (US); Weiling Zhang, Sunnyvale, CA (US); Markus Wieser, San Carlos, CA (US); Deborah Rodgers, Framingham, MA (US)

Correspondence Address: FISH & RICHARDSON, P.C., PO BOX 1022, MINNEAPOLIS, MN, 55440-1022, US

(21) Appl. No.: 10/884,169

(22) Filed: Jul. 2, 2004

Related U.S. Application Data
(60) Provisional application No. 60/514,263, filed on Oct. 23, 2003.

(51) Int. Cl. H04M 1/64; H04L 12/16

(52) U.S. Cl. 370/270; 379/88.17

(57) ABSTRACT

An agent or customer representative can use a graphical user interface (GUI) when the agent is in contact with one or more customers. In a computer-implemented method for providing navigational aids to the GUI for an interaction center, the method can include displaying the GUI with a work area for an agent and a navigation area. The navigation area can include a standard section with multiple links defined for the agent at a supervisory level and a personalized section of the navigation bar. The personalized section can include one or more links selected by the agent at an agent level from a list of links compiled for the agent in the supervisory level.

### CROSS REFERENCE TO RELATED APPLICATIONS

This application claims the benefit of priority from U.S. Provisional Application entitled “NAVIGATIONAL BAR”, filed Oct. 23, 2003, Application Ser. No. 60/514,263, the disclosure of which is incorporated by reference.

### BACKGROUND

The following description relates to customer service tools, for example, providing customer tools and services to customer service agents and customer service interaction centers.

In recent years, telephone interaction centers have become much more widespread. The interaction centers manage many efforts, and interaction center agents working in these centers often place and receive thousands of calls to and from various customers in different regions of the country. These agents often use headsets to speak with customers while they concurrently enter information relating to the customers into a computer workstation. The workstation may provide electronic forms for the entry of customer information.

More recently, telephone interaction centers have evolved into full-scale interaction centers, wherein agents may interact with customers via telephone, email, fax, or chat communication channels. Through the use of these interaction centers, agents are able to interact with customers in many different ways.

Additionally, agents have the ability to interact with two or more customers at the same time. For instance, an agent may be able to speak with one customer on the phone and concurrently interact with another customer in a chat session. As a result, the agent may be able to improve his or her efficiency.

When handling contacts with one or more customers, customer service agents may want to quickly view several sources of information. For instance, a customer service agent may want to quickly access information for a sales order for one customer, while searching through a product catalog to assist another customer. If the agent is on a phone call with a customer, for example, the agent may need to quickly view the customer's data and order history. The agent may also need to quickly view a responsible company's policies on orders, products, and shipping. If the agent has a difficult time finding customer information then workflow inefficiencies can result. Furthermore, if the customer service agent keeps the customer waiting a long period of time for service, the customer may regard the customer service as poor and may be reluctant to conduct business again with the agent's company.

### SUMMARY

The present application describes systems and techniques relating to providing quick and easy-to-understand navigation tools with a graphical user interface (GUI) for an agent. In one implementation, a computer-implemented method for providing navigational aids to a graphical user interface for an interaction center includes displaying a GUI that has a work area for an agent and a navigation area. The navigation area includes a personalized section and a standard section, with the standard section including multiple links defined for the agent at a supervisory level. The personalized section includes one or more links that are selected by the agent at an agent level from a list of links compiled for the agent in the supervisory level.

In one aspect, links in the standard section may be common to multiple agents. One or more links in the standard section can include information that corresponds to an interaction between the agent and a customer. The information can include information related to a sale and/or customer information. The navigation area can include: (1) links to process pages that may correspond to processes for servicing a customer; and (2) topic pages in the process pages, in which the topic pages can refer to one or more items for investigation, information, and research.

In another aspect, there may be a link to an index page in the personalized section of the navigation area, in which the index page may have a complete list of standard and personalized links for the navigation area. The personalized section may have a link to scripts used by the agent, as well as a link to information associated with customers assigned to the agent. The predefined list can be compiled in response to a role assigned to the agent.

In another implementation, a system for an interaction center includes a graphical user interface for an interaction center agent. The graphical user interface has a navigation area and a link to an index page that has a complete list of standard and personalized links for the navigation area. The navigation area includes a standard section with links defined for an interaction center agent, and a personalized section with interaction center agent-selectable links.

In one aspect, the standard section can include links that are common to at least two interaction center agents. The links defined for the interaction center agent may be defined at a supervisory level. The interaction center agent-selectable links can be configured to be selected by the interaction center agent at an agent level from a list of links compiled for the interaction center agent in a supervisory level. The standard section can include links that are frequently-used links, and the navigation area can be persistently displayed in the graphical user interface. The navigation area may also have links to one or more process pages that refer to one or more processes that the interaction center agent performs with a customer order. The process pages can include one or more topic pages that refer to one or more items for investigation, information, and research.

The graphical user interface can have an interaction center agent's workspace, and the navigation area can include links, shortcuts, and headers for the interaction center agent's workspace. The complete list of standard links for the navigation area may include a complete list of links defined for one or more interaction center agents, and the complete list of personalized links for the navigation area may include a complete list of links to be selected by the interaction center agent.

In another implementation, a computer-implemented method involves displaying a navigation area to a user in a graphical user interface, in which the navigation area guides the user through a workflow procedure in an interaction center having multiple steps. The method also involves displaying a help section within the navigation area that has links to multiple help pages and process pages. At least one of the help pages and process pages can include links to other pages to provide content and workflow utilities for interaction center agents.

The method may involve linking an index page to the navigation area, in which the index page can have a complete list of standard and personalized links for the navigation area. The method may include defining the complete list of standard links for the navigation area for the interaction center agents. The complete list of personalized links for the navigation area may include a complete list of links to be selected by the interaction center agent. The help section may present a navigable list of help-related links in the navigation area, and may allow the interaction center agents to conform to business procedures for a customer's order.

The method may also involve providing one or more scripts in the navigation area for suggested wording for an interaction center agent to use for a customer's order. The suggested wording of the script can protect and promote the interaction center's business practices.

In another implementation, an article includes a machine-readable medium storing instructions to cause a machine to perform operations for providing navigational aids to a graphical user interface for an interaction center. The operations include displaying a GUI with a work area for an agent and a navigation area. The navigation area includes a personalized section and a standard section, with the standard section including multiple links defined for the agent at a supervisory level. The personalized section includes one or more links that are selected by the agent at an agent level from a list of links compiled for the agent in the supervisory level.

The systems and techniques described here may provide one or more of the following advantages. A navigation bar in a graphical user interface can provide a customer service agent quick access to information. The information may include sales orders, customer data, contacts, policies, products, and personalized links. The navigation bar may improve the efficiencies of the customer service agent and reduce the amount of time a customer service agent spends on finding information. The navigation bar can also guide the agent in preferred workflow procedures. Hence, the amount of time the customer spends waiting for service can be reduced, and the customer can have a positive view of the responsiveness of the agent's service.

As another benefit, the navigation bar can be easily customized by an agent or an agent's supervisor. The customization features of the navigation bar can reduce the burden an information technology staff may have in performing personalized navigation bar sections for each agent in a company.

Details of one or more implementations are set forth in the accompanying drawings and the description below. Other features and advantages will be apparent from the description and drawings, and from the claims.

### DRAWING DESCRIPTIONS

FIG. 1A illustrates a system for a customer service agent.

FIG. 1B shows an exemplary graphical user interface with a navigation bar.

FIG. 2A shows an exemplary navigation bar.

FIG. 2B shows an exemplary index page.

FIG. 3 shows exemplary navigation bar customization code.

FIG. 4 shows an exemplary diagram of navigational guidance using a navigation bar.

FIG. 5 shows an exemplary diagram of navigational procedural help using a navigation bar.

FIG. 6 shows an exemplary diagram of a scripting model.

Like reference symbols in the various drawings indicate like elements.

### DETAILED DESCRIPTION

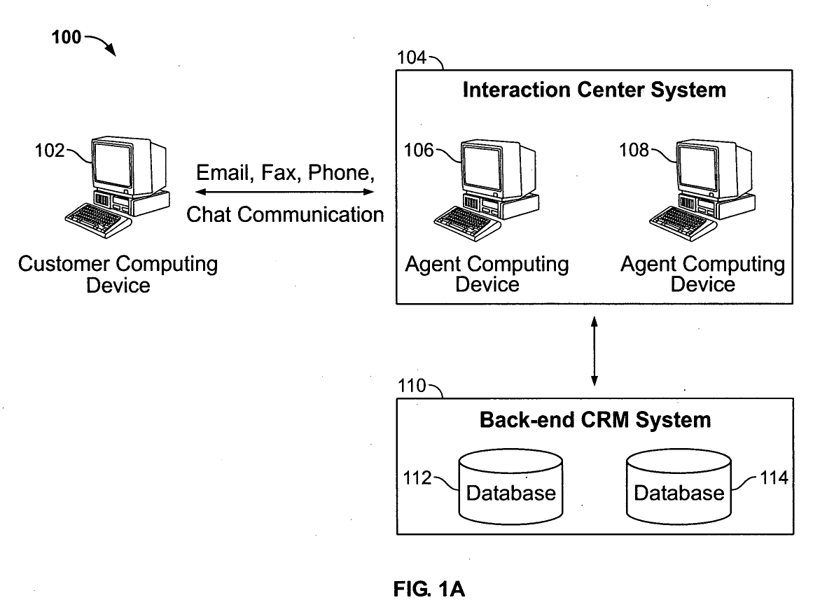

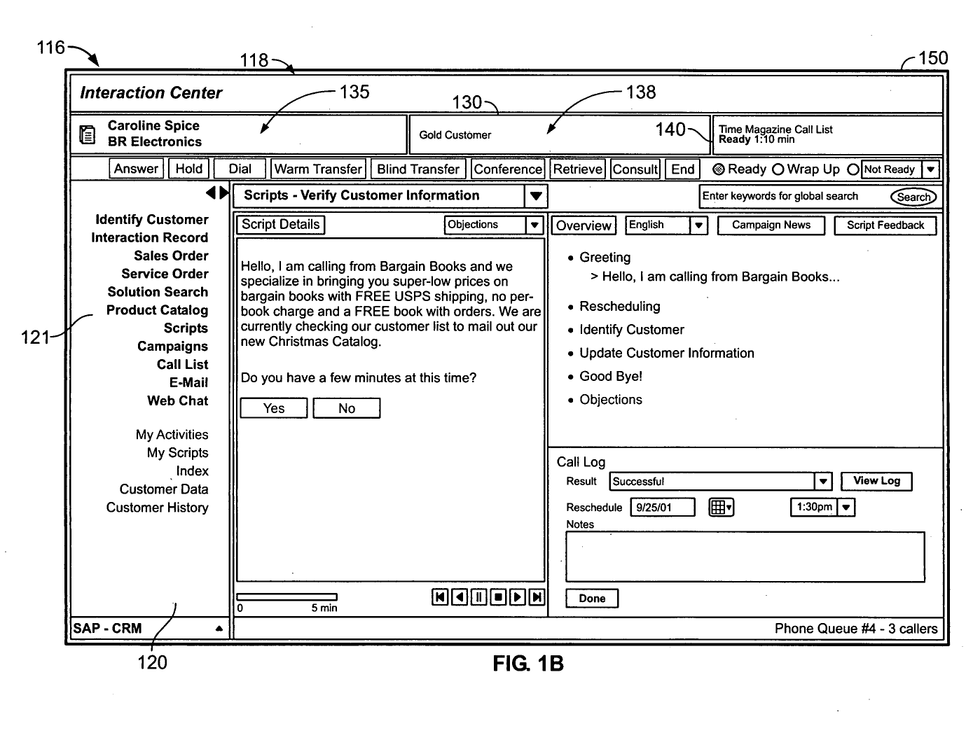

The systems and techniques described here relate to providing navigation tools for one or more customer service representatives or agents in a graphical user interface (GUI). FIG. 1A is a block diagram of a system 100 that may be used during interactions between a customer and a customer service agent, according to one embodiment. In this embodiment, the customer uses a computing device 102 to interact with the agent, and the agent uses a computing device 106 or 108 within an interaction center system 104. However, the customer may interact with the agent in the interaction center using various different modes of communication. For example, the customer may communicate with the agent in the interaction center system 104 by email, fax, phone, or interactive chat session using the computing device 102 or other device (e.g., telephone, PDA (Personal Digital Assistant), wireless handheld, etc.). The agent may to respond to the customer using these and other modes of communication. In one embodiment, the customer initiates the interaction with the agent by generating a request that is sent from the computing device 102 to the interaction center system 104. In one embodiment, the interaction center system 104 contains a server management system (not shown) that interacts with each agent computing device 106 and 108. In this embodiment, the server management system helps manage and oversee the interaction between the customer computing device 102 and the agent computing devices 106 and 108. The agent computing devices 106 and 108 may continually interact with the server management system during the course of any given interaction.

During any given interaction with the customer, the interaction center system 104 often needs to exchange information with a back-end customer relationship management (CRM) system 110. The back-end system 110 contains databases 112 and 114. The interaction center system 104 may access the databases 112 and 114 during any given interaction with a customer. In one embodiment, the databases 112 and 114 contain customer information, historical information, and transaction (e.g., sales order or service order) information.

A navigation bar in the GUI for a customer service agent may have one or more links to enable a user to quickly access information to resources and contacts. The navigation bar may be shown prominently in a context persistent area of the GUI (i.e., a section that is persistently displayed for the user).

In order to allow the customer service agent to quickly view and access items, the navigation bar should contain a list of items that is sufficient to allow the agent to quickly access the most-used resources. For example, the list of items may include links to a sales order, a service order, and a product catalog. The navigation bar is meant to give quick access to frequently-used items and/or topics. Accordingly, the navigation bar does not necessarily include an exhaustive or comprehensive list of items. A navigation bar with an exhaustive list of items can overwhelm an agent during a call and reduce the agent's efficiency and response time for the customer.

The interaction center is a dynamic environment with multiple agents responding to many customers with one or more orders for each customer. When agents respond quickly and accurately to customers in such a dynamic environment, the customer satisfaction of the business can be improved.

In general, the navigation bar may have around, e.g., 10-20 links to independent pages. Of those independent pages, some of the independent pages may be process pages, and other independent pages may be topic pages. The process pages can refer to one or more processes that an agent may perform to service a customer, such as one or more processes to complete an order. The topic pages can refer to one or more items for investigation, information, or research, such as providing an index of topics.

FIG. 1B shows exemplary GUI 116 with the navigation bar 120. The GUI 116 can be presented on a display device for an agent that handles calls, emails, and/or chat sessions from one or more persons. In this example, the GUI has five sections: (1) a title bar 118; (2) a context area 130; (3) an agent status indicator 140; (4) a workspace 150; and (5) a navigation bar 120. The navigation bar 120 can display certain links, shortcuts, or headers for the agent's workspace 150. The context area 130 can include the agent's status indicator 140, as well as a section for the caller's name and/or organization 135, and a section for alerts or special caller information 138.

In general, the navigation bar 120 is populated with the essential user links. The order of the links in the navigation bar can be arranged to reflect a preferred work practice and process for the agent. The navigation bar 120 can have groups of links that are separated in the GUI to enhance visibility to the agent. The navigation bar 120 is also intended to provide a simplified and uncomplicated view of items to an agent. As such, scroll bars and complex nested links and tree structures may be avoided, as they may be too overwhelming for an agent to use effectively within the short amount of time given for customer service.

The navigation bar 120 may include an index or search tool to give users a “back door” glimpse into all possible navigation targets. However, a comprehensive list of possible navigation targets need not be shown, but only the most likely or most used targets.

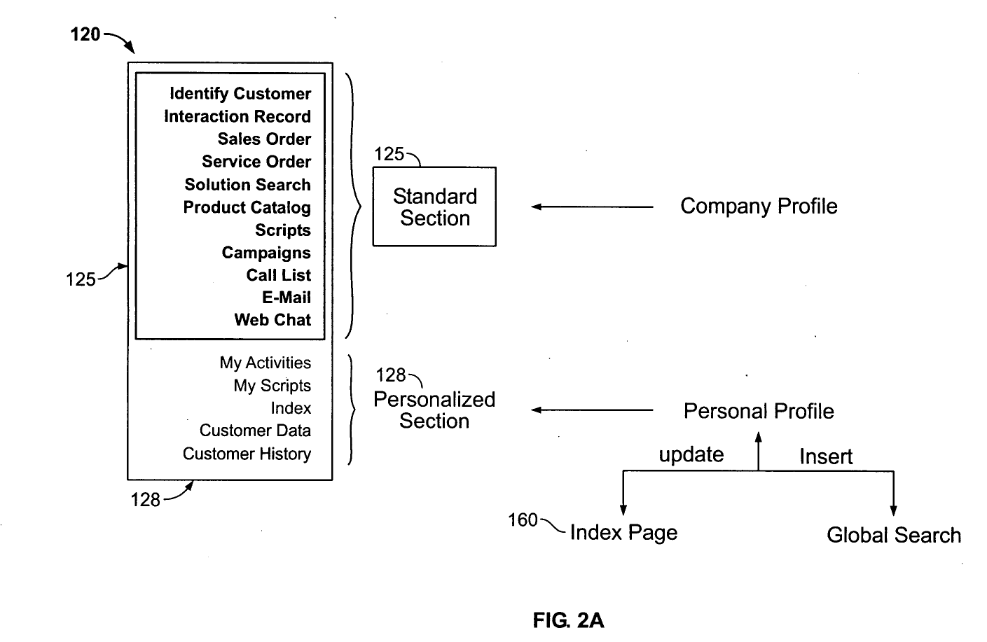

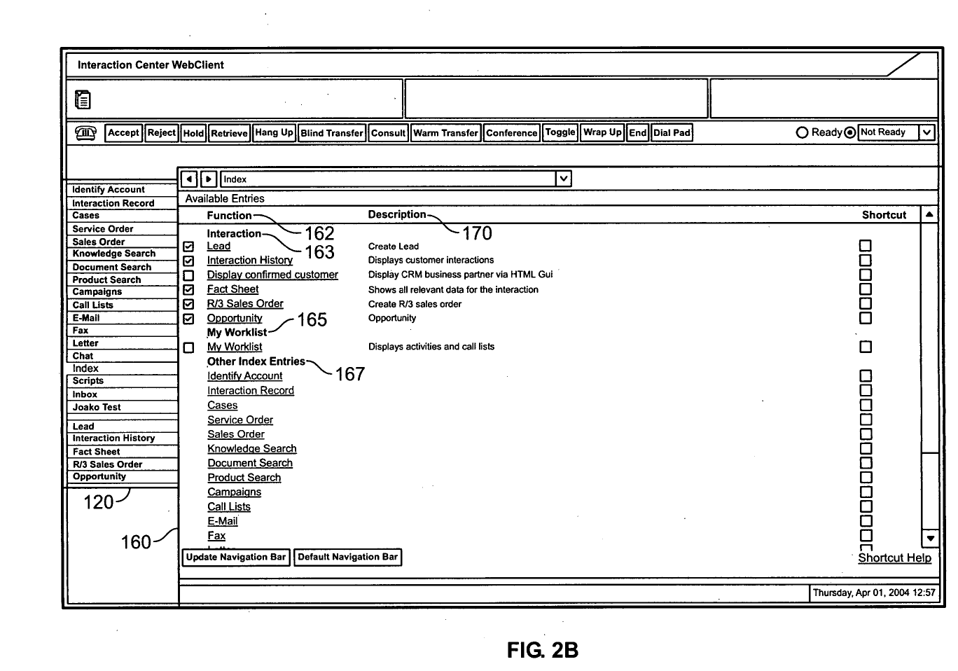

FIG. 2A shows the navigation bar 120 in context area 130 with greater detail. In this illustration, the navigation bar 120 can have several sections, with each section providing different types of information to the agent. A standard section 125 may include links to frequently used items. The standard section 125 may include items that are common to several customer service agents in a customer service center. The customer service center can make these common items the standard listed items for multiple agents. The type and/or position of the links in this section 125 may be determined by the company profile 125 or the manager in charge of the agents. Typically, the links can be displayed in bold text to offer greater visibility to the agent. When a link is selected, such as link 121 in FIG. 1B, the current frameset or area around the selected link can be highlighted to let the agent know what item is selected.

The standard section 125 may also have one or more items that are commonly performed by certain groups of customer service agents. Hence, rather than assign those items to all agents, a company can choose and assign items that are based on the role of certain groups of customer service agents. For example, a role may be added to the agents' profiles. Roles for agents may include, e.g., sales and telemarketing, customer service, technical support, transactional, campaigning, etc. One or more such roles may be associated with an individual agent's profile. Other roles may be associated based on the type of communication of the agent. For example, the agent may be categorized as an agent handling only email, or only telephone call, or only chat-like communications.

A personalized section 128 is shown at the bottom of the navigation bar 120. The personalized section 128 can be customized with one or more items by an agent and/or the agent's manager. The personalized section 128 may be customized for a personal profile of an agent. A customization wizard may be provided to aid the agent in selecting links for the personalization section 128. The customization wizard may use the agent's profile (e.g., role) to compile a list of links for the agent to select from. The customization wizard may provide one or more descriptive pages with options for selecting links and/or a brief summary of the contents of the liked pages.

In one aspect, the personalized section 128 can have a link to an index page 160. The index page 160 may have a comprehensive list of all possible links that are available to the agent, in which the list is arranged by topic. The index page 160 may be periodically updated by the agent's company with the most recent information on orders, customers, policies, and services. The agent may elect to add one or more items from the index page to the personalized section 128. In another aspect, the personalized section 128 includes a link to a page that allows the agent to insert one or more search terms.

In one implementation, the navigation bar can be created with two levels: a supervisor level and a user/agent level. In the supervisor level, the supervisor for one or more agents has permission to select the standard functionality and the links that should be used for the agents. The supervisor may also choose the items that are listed in the index page for the agents. The agents do not have the permission create a navigation bar for other agents, or to select items in the navigation bar or index page for other agents. In the user/agent level, the agent has permission to choose their own personalized links for the navigation bar. The agent may select from one or more items in an index page of potential links.

FIG. 2B shows an exemplary index page 160. The index page 160 can include company-specific and/or interaction center-specific items for one or more functions 162. The one or more functions 162 may have corresponding descriptions 170. The one or more functions 162 include an interaction list 163 with one or more links relating to an order. A personal worklist 165 for the customer service agent can display the activities and call lists of the agent. The index page 160 may have other index entries 167 to allow the customer service agent to quickly access other key company-specific and/or interaction center-specific items.

The navigation bar 120 includes the items under other index entries 167 by default. For example, the other index entries 167 are items that are selected by the company and/or the interaction center. The customer service agent may personalize their navigation bar 120 by selecting the items listed under “interaction” 163 and “my worklist” 165 to be listed in their navigation bar 120.

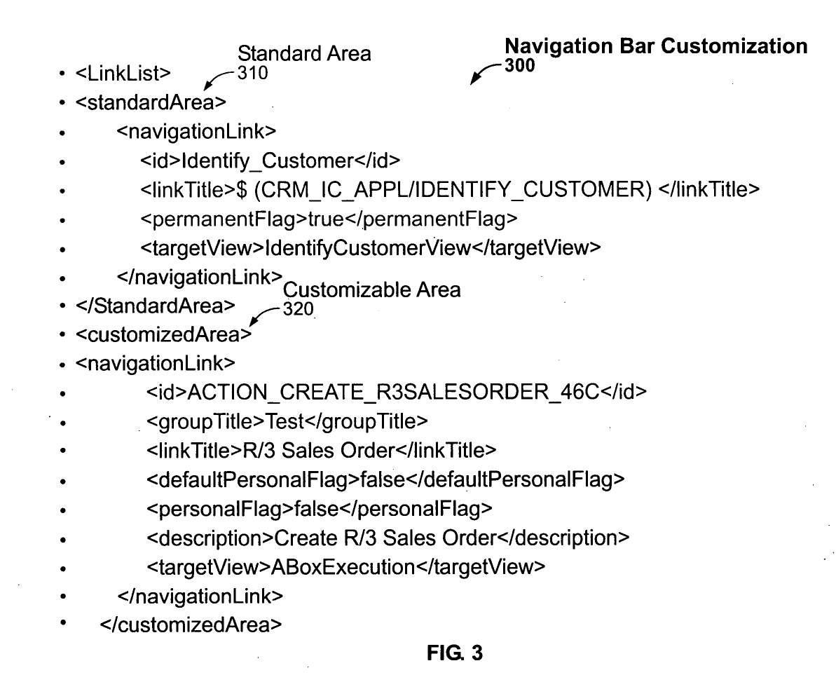

FIG. 3 shows exemplary customizable navigation bar code 300. The navigation bar code 300 may be part of an eXtensible Markup Language (XML) file. The link entries of the navigational bar can be retrieved from a customized XML file. The navigation bar code 306 can include information for the standard and customized areas (standardArea 310, customizedArea 320) of the navigation link. The navigational link entries can be loaded from the XML file into a runtime repository. The XML file can allow full customization of the navigation bar. In addition to or instead of XML file customization, customization may also be performed by a wizard driven utility that guides customization in a step-by-step process.

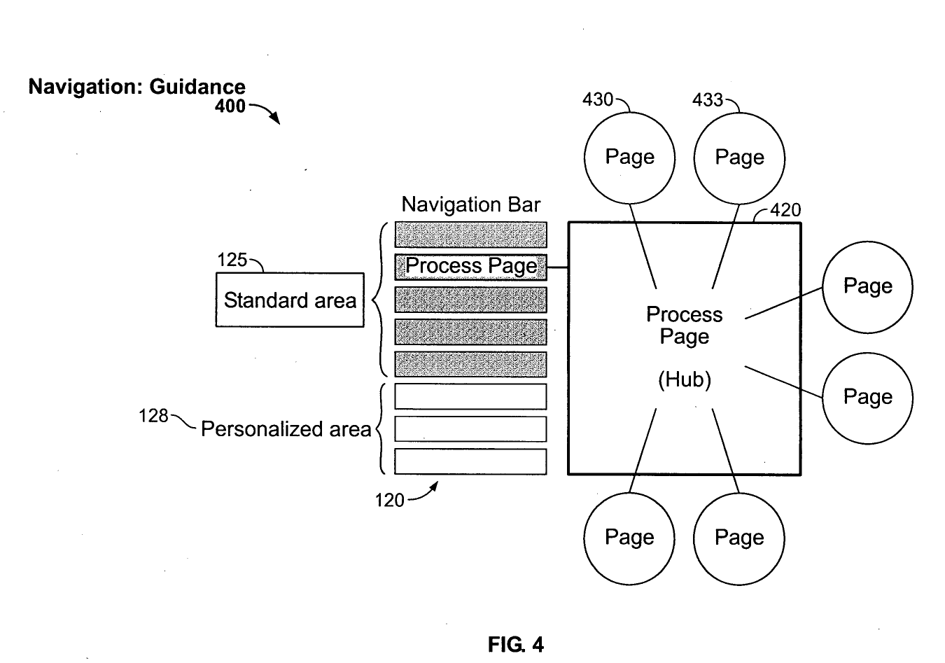

FIGS. 4-6 show examples of navigational assistance that can be provided by the navigational bar 120. In FIG. 4, the navigational bar can provide guidance to a process page 420. The process page 420 can link to other pages 430, 433 that provide content and workflow utilities for one or more agents.

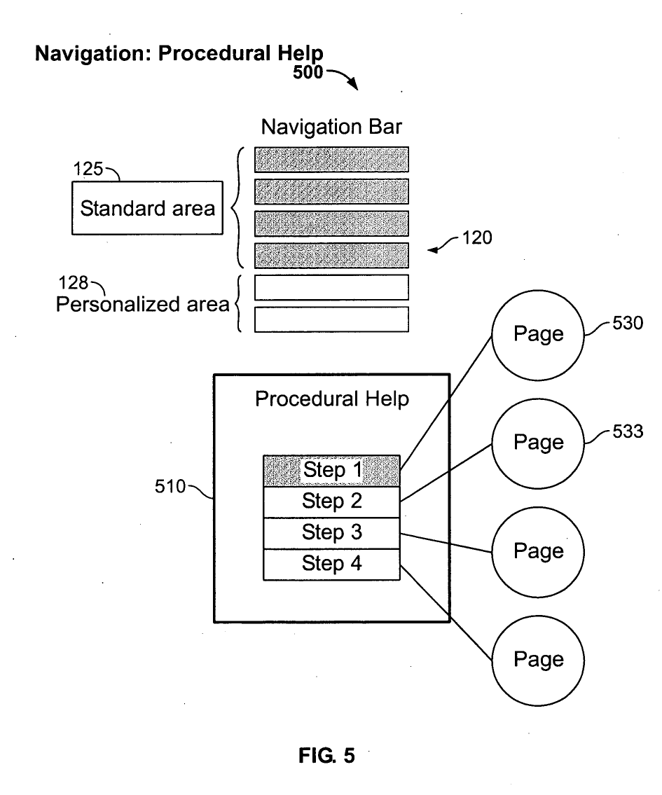

In FIG. 5, the navigational bar can provide one or more items for procedural help 510. The procedural help items(s) can allow users to view a navigable, dynamic list of steps in the navigation bar to links to one or more pages 530, 533, in which each link details a step. The procedural help items can allow the customer service agents to conform to specific business processes. For example, a customer service agent may need to conform to specific procedures and questions in order to complete a customer's order, such as stating shipping timeframes and product return policies.

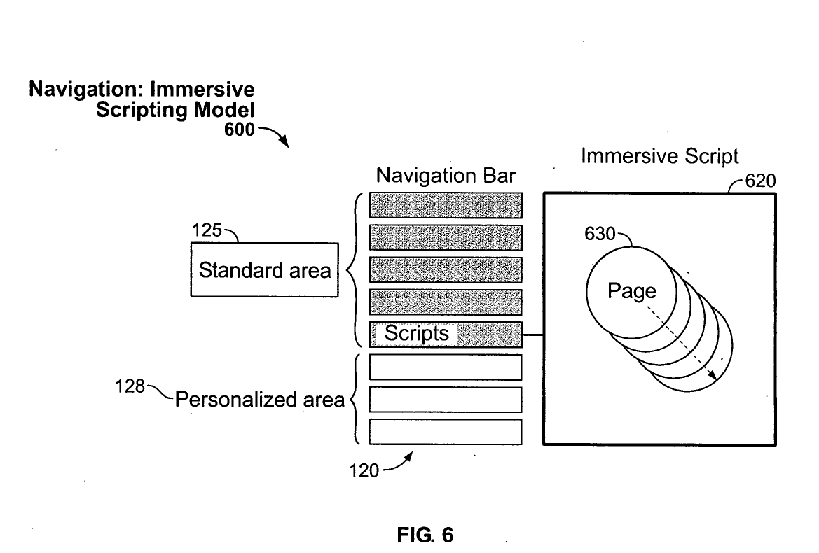

In FIG. 6, the navigational bar may provide a link to one or more scripts that are used by the agent. The script may represent an exact wording or phrasing that an agent may use on a call. The wording may be defined by the interaction center, and may help to protect and promote the interaction center's business practices. The links to the one or more scripts may open one or more pages of scripts for various customer service tasks.

In another aspect, the navigation bar items may have dynamic links instead of or in addition to static links. Typically when a navigation bar item is selected, navigation is performed to a static link that is defined in the navigation bar profile. In some cases, when a navigation bar item is selected, a dynamic link is utilized at runtime. For example, if a script item has multiple templates, then the actual template that is selected may be determined by one or more user commands at runtime. For example, an order may require that the agent inform the customer of a particular method of shipping, or may require an additional processing fee for shipping to certain jurisdictions.

Various implementations of the systems and techniques described here can be realized in digital electronic circuitry, integrated circuitry, specially designed ASICs (application specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device.

The software (also known as programs, software tools or code) may include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on one or more computers each having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input. The components of the system can be interconnected by any form or medium of digital data communication (e.g., a communication network). Examples of communication networks include a local area network (“LAN”), a wide area network (“WAN”), a wireless local area network (“WLAN”), a personal area network (“PAN”), a mobile communication network using a multiple access technology (e.g., a cellular phone network with Code Division Multiple Access, “CDMA”), and the Internet.

The computing system can include clients and servers. A client and server are generally remote from each other and typically interact through a communication network. The relationship of client and server arises by virtue of computer programs running on the respective computers and having a client-server relationship to each other.

Although only a few implementations have been described in detail above, other modifications are possible. There may be other communication scenarios not described. The user interfaces described above may be referred to as panels, palettes, pages, views, or portions of other interfaces. Other implementations may be within the scope of the following claims.

1. A computer-implemented method for providing navigational aids to a graphical user interface (GUI) for an interaction center, the method comprising:
displaying a GUI including a work area for an agent and a navigation area, the navigation area including:
a standard section including a plurality of links defined for the agent at a supervisory level; and
a personalized section of the navigation bar, the personalized section including one or more links selected by the agent at an agent level from a list of links compiled for the agent in the supervisory level.

2. The method of claim 1, further comprising:
including links in the standard section that are common to a plurality of agents.

3. The method of claim 1, wherein one or more of the links in the standard section link to pages include information corresponding to an interaction between the agent and a customer.

4. The method of claim 3, wherein the information comprises information related to a sale.

5. The method of claim 3, wherein the information comprises customer information.

6. The method of claim 1, wherein the navigation area includes one or more links to one or more process pages corresponding to processes for servicing a customer.

7. The method of claim 6, further comprising one or more topic pages in the one or more process pages, wherein the one or more topic pages refer to one or more items for investigation, information, and research.

8. The method of claim 1, further comprising:
including a link to an index page in the personalized section of the navigation area, wherein the index page comprises a complete list of standard and personalized links for the navigation area.

9. The method of claim 1, wherein the personalized section comprises a link to scripts used by the agent.

10. The method of claim 1, wherein the personalized section comprises a link to information associated with customers assigned to the agent.

11. The method of claim 1, wherein the predefined list is compiled in response to a role assigned to the agent.

12. A system for an interaction center, comprising:
a graphical user interface for an interaction center agent, the graphical user interface including:
a navigation area comprising:
a standard section including links defined for an interaction center agent;
a personalized section including interaction center agent-selectable links; and
a link to an index page that comprises a complete list of standard and personalized links for the navigation area.

13. The system of claim 12, wherein the standard section includes links that are common to at least two interaction center agents.

14. The system of claim 12, wherein the links defined for the interaction center agent are defined at a supervisory level.

15. The system of claim 12, wherein the interaction center agent-selectable links are configured to be selected by the interaction center agent at an agent level from a list of links compiled for the interaction center agent in a supervisory level.

16. The system of claim 12, wherein the standard section includes links that are frequently used links.

17. The system of claim 12, wherein the navigation area is persistently displayed in the graphical user interface.

18. The system of claim 12, wherein the navigation area comprises one or more links to one or more process pages.

19. The system of claim 18, wherein the one or more process pages refer to one or more processes that the interaction center agent performs with a customer order.

20. The system of claim 18, wherein the one or more process pages comprise one or more topic pages, wherein the one or more topic pages refer to one or more items for investigation, information, and research.

21. The system of claim 12, wherein the graphical user interface comprises an interaction center agent's workspace, wherein the navigation area comprises links, shortcuts, and headers for the interaction center agent's workspace.

22. The system of claim 12, wherein the complete list of standard links for the navigation area comprises a complete list of links defined for one or more interaction center agents.

23. The system of claim 12, wherein the complete list of personalized links for the navigation area comprises a complete list of links to be selected by the interaction center agent.

24. A computer-implemented method, the method comprising:
displaying a navigation area to a user in a graphical user interface (GUI), the navigation area being operative to guide the user through a workflow procedure in an interaction center having a plurality of steps; and
displaying a help section within the navigation area, the help section having links to a plurality of help pages and process pages, wherein at least one of the help pages and process pages comprises links to other pages to provide content and workflow utilities for one or more interaction center agents.

25. The method of claim 24, further comprising linking an index page to the navigation area, wherein the index page comprises a complete list of standard and personalized links for the navigation area.

26. The method of claim 25, further comprising defining the complete list of standard links for the navigation area for one or more interaction center agents.

27. The method of claim 25, wherein the complete list of personalized links for the navigation area comprises a complete list of links to be selected by the interaction center agent.

28. The method of claim 24, wherein the help section presents a navigable list of help-related links in the navigation area.

29. The method of claim 28, wherein the help section is adapted to allow the interaction center agents to conform to business procedures for a customer's order.

30. The method of claim 24, further comprising providing one or more scripts in the navigation area, wherein the script comprises suggested wording for an interaction center agent to use for a customer's order.

31. The method of claim 30, wherein the suggested wording of the script protects and promotes the interaction center's business practices.

32. An article comprising a machine-readable medium storing instructions operable to cause a machine to perform operations for providing navigational aids to a graphical user interface (GUI) for an interaction center, the operations comprising:
display a GUI including a work area for an agent and a navigation area, the navigation area including:
a standard section including a plurality of links defined for the agent at a supervisory level; and
a personalized section of the navigation bar, the personalized section including one or more links selected by the agent at an agent level from a list of links compiled for the agent in the supervisory level.

33. The article of claim 32, wherein the operations further comprise:
include a link to an index page in the personalized section of the navigation area, wherein the index page comprises a complete list of standard and personalized links for the navigation area.
